(19) United States
(12) Patent Application Publication
(10) Pub. No.: US 2010/0000836 A1
(43) Pub. Date: Jan. 7, 2010

(54) Electromagnetic clutch

(75) Inventor: Mototsugu ARAI, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/458,112

(22) Filed: Jun. 30, 2009

(30) Foreign Application Priority Data
Jul. 1, 2008 (JP) 2008-172488

(51) Int. Cl. F16D 27/02

(52) U.S. Cl. 192/84.961

(57) ABSTRACT

A clutch generating stress equally at a plurality of bridges parts of a driving side clutch plate to thereby prevent bridge parts from breaking easily during transmission of drive power, wherein a plurality of hole parts 13c and 13d are formed, arranged in a circumferential direction, respectively at the outer circumference side and inner circumference side of a driving side clutch plate 13b, and bridge parts 13e and 13f are formed adjacent in a circumferential direction between the hole parts 13c and 13d, the driving side clutch plate 13b comprises a friction surface 13a pressed to the driven side clutch plate 18 and an opposite friction surface 13h on the opposite side of the friction surface, and a thickness t1 of the inner circumference side is greater than a thickness t2 of the outer circumference side of the same with respect to the plate thickness between the friction surface 13a and the opposite friction surface 13h.

### BACKGROUND OF THE INVENTION

1. Field of the Invention

The present invention relates to a clutch and in particular is effectively applicable to an electromagnetic clutch.

2. Description of the Related Art

An electromagnetic clutch or other friction clutch presses together clutch plates and transmits drive power by the frictional force generated at the contacting surfaces. As set forth in Japanese Patent Publication (A) No. 2003-254350, an electromagnetic clutch 90 transmitting drive power to a compressor of a vehicular air-conditioner is provided with a rotor 13 which comprises an external cylinder part 11 around which is wrapped a belt transmitting drive power of a drive source and a driving side clutch plate 13b integrally formed with the external cylinder part 11. By a driven side clutch plate 18 being pressed against the driving side clutch plate 13b, it generates frictional force at the contacting surfaces of the two clutch plates 13b and 18 and uses the frictional force to transmit drive power. Further, the driving side clutch plate 13b has pluralities of holes 13c and 13d arranged in a circumferential direction formed at an outer circumference side and an inner circumference side. Further between the hole parts 13c and 13d adjacent in the circumferential direction, bridge parts 13e and 13f are respectively formed (see FIGS. 6 to 8). These holes will be explained later, but are for increasing the electromagnetic attraction force.

On the other hand, as shown in FIG. 9, if a bending moment acts on the rotor 13 due to a tension force T of the belt wrapped around the rotor, tensile stress S1 is generated at the friction surface 13a side of the bridge parts. It has been found that the tensile stress S1 generated at the friction surface 13a side causes fatigue fracture from the friction surface 13a side. The invention of Japanese Patent Publication (A) No. 2003-254350, in consideration of the above point, suppresses the occurrence of fatigue fracture at the bridge parts of a clutch plate of a rotor of an electromagnetic clutch by providing a press formed part 13y (see FIG. 7(b)) at the friction surface 13a side of the bridge part of the driving side clutch plate 13b to increase the hardness.

However, as shown in FIG. 9, if a bending moment acts on the rotor 13 through the tension force T of the belt wrapped around the rotor, a tensile stress S2 will be generated not only at the friction surface 13a side of the bridge parts, but also at the opposite side 13h of the friction surface 13a. It is learned that the tensile stress S2 generated at this friction surface 13a side causes fatigue fracture from the opposite side 13h of the friction surface 13a as well. Further, it was found that in the bending forces applied to the bridge parts, the bending force applied to the bridge parts on the inner circumference side is larger than the bending force applied to the bridge parts on the outer circumference side. That is, it was learned that the inner circumference side bridge parts are more susceptible to breakage in comparison to the outer circumference side bridge parts.

### SUMMARY OF THE INVENTION

An object of the present invention, in consideration of the above points, is to provide a clutch generating stress equally at the pluralities of bridge parts of a driving side clutch plate when transmitting drive power to thereby prevent bridge parts from breaking easily.

In the present invention, there are provided clutches as set forth in the claims of the claim section as technical means for solving the problem. According to a first aspect of the present invention, there is provided a clutch wherein pluralities of holes (13c and 13d) are formed, arranged in a circumferential direction, respectively at an outer circumference side and inner circumference side of a driving side clutch plate (13b), bridge parts (13e and 13f) are formed adjacent in the circumferential direction between the plurality of holes (13c and 13d); the driving side clutch plate (13b) comprises a friction surface (13a) pressed to a driven side clutch plate (18) and an opposite friction surface (13h) on the opposite side of the friction surface; and, regarding the thickness between the friction surface (13a) and the opposite friction surface (13h), a thickness (t1) of the inner circumference side is greater than a plate thickness (t2) of the outer circumference side.

Concerning bending force applied to the bridge parts of the driving side clutch plate when transmitting drive power, the bending force applied to the bridge parts of the inner circumference side is greater than the bending force applied to the bridge parts of the outer circumference side. Therefore, by making the thickness (t1) of the bridge parts (13f) of the inner circumference side sufficiently greater than the thickness (t2) of the bridge parts (13e) of the outer circumference side, stress is made to be equally generated at the bridge parts of the inner circumference side and the outer circumference side, and breakage at the bridge parts of the inner circumference side and the outer circumference side can be prevented.

According to a second aspect of the present invention, there is provided a clutch wherein the opposite friction surface (13h) is provided with a step difference or slanted surface (13g) from the inner circumference side to the outer circumference side. This expresses a specific shape of an opposite friction surface (13h).

According to a third aspect of the present invention, there is provided a clutch wherein the pluralities of holes (13c and 13d) arranged in the circumferential direction are elongated holes long in the circumferential direction and short in the radial direction.

According to a fourth aspect of the present invention, there is provided a clutch wherein the driving side clutch plate (13b) forms a magnetic path of a magnetic field induced by an excitation coil (12), and the driven side clutch plate (18) is an armature attached by the electromagnetic attraction force to the driving side clutch plate (13b). This expresses that the clutch of the present invention is applicable to an electromagnetic clutch.

Note that the notations in the parentheses of each of the above means show the correspondence with specific means described in the later mentioned embodiments.

### BRIEF DESCRIPTION OF THE DRAWINGS

These and other objects and features of the present invention will become clearer from the following description of the preferred embodiments given with reference to the attached drawings, wherein:

FIG. 1 is a cross-sectional view of an electromagnetic clutch according to a first aspect of the present invention;

FIG. 2 is a cross-sectional view of a rotor of the electromagnetic clutch of FIG. 1;

FIG. 3 is a back view of the rotor of FIG. 2 seen from a Y-direction;

FIG. 4 is an enlarged view of a B part of FIG. 2;

FIG. 5 is a cross-sectional view of the rotor of an electromagnetic clutch according to a second aspect of the present invention;

FIG. 6 is a cross-sectional view of a conventional electromagnetic clutch;

FIG. 7A is a cross-sectional view of the rotor of the electromagnetic clutch of FIG. 6, and FIG. 7B is an expanded view of an A part of FIG. 7A;

FIG. 8 is a back view of the rotor of FIG. 7A seen from the Y-direction; and

FIG. 9 is a view explaining the forces applied to a rotor.

### DESCRIPTION OF THE PREFERRED EMBODIMENTS

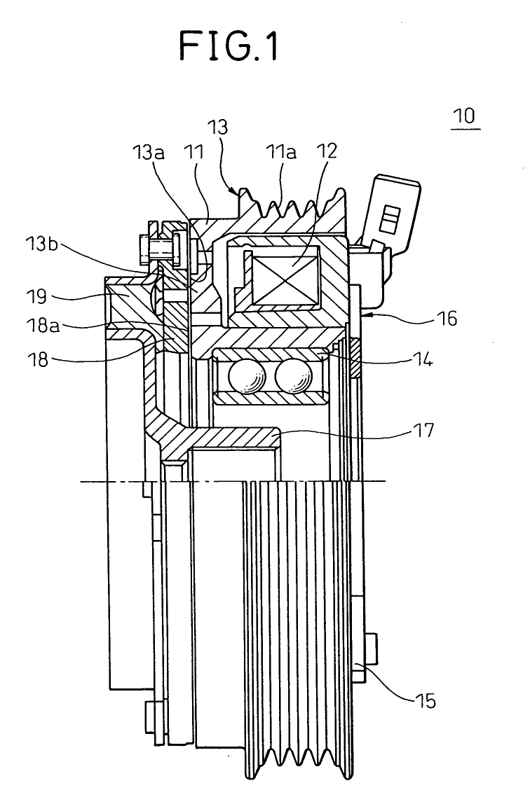

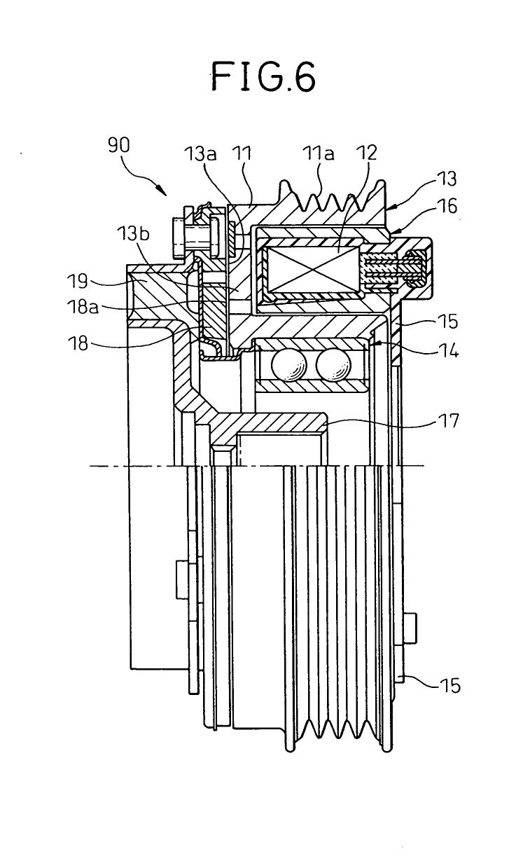

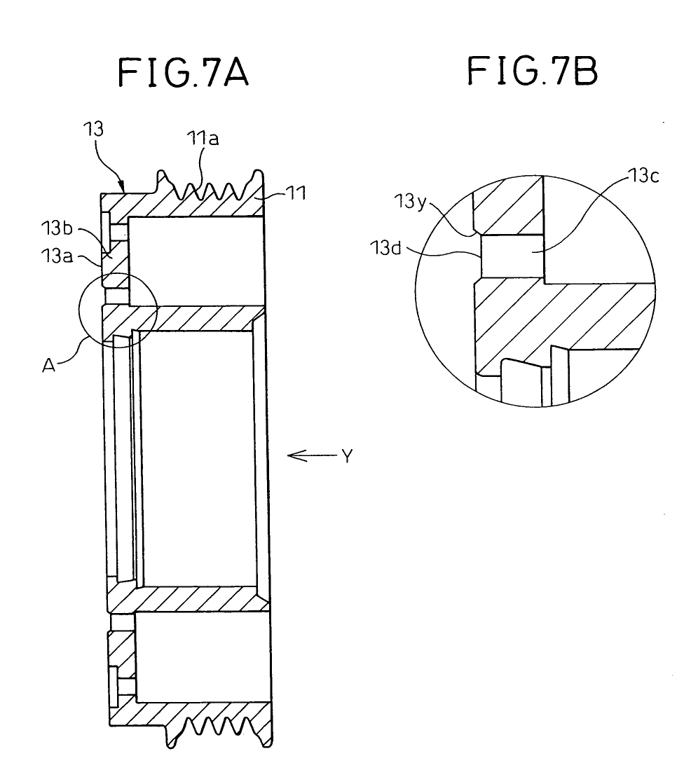

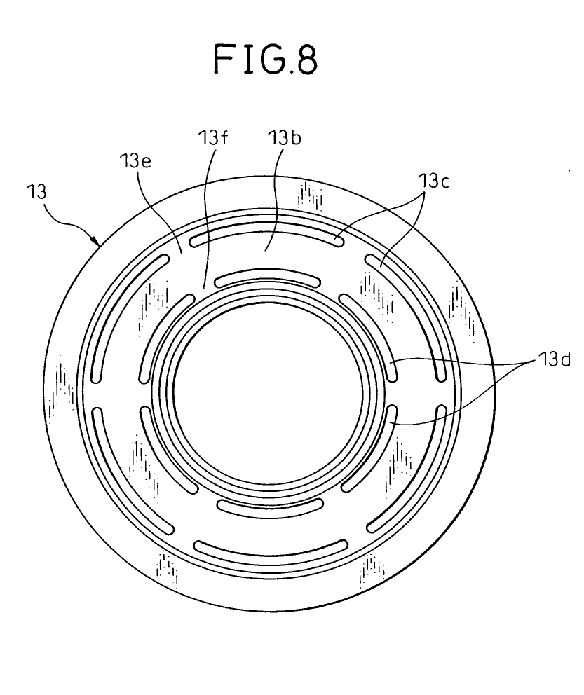

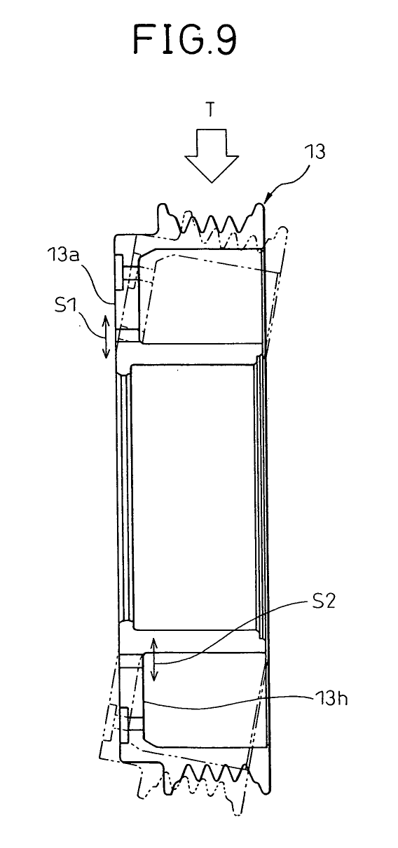

The electromagnetic clutch according to the present invention is used for transmitting a drive power of an engine to a compressor of a vehicular cooling cycle. Note that, in the drawings, FIG. 1 to FIG. 9 for explaining an electromagnetic clutch according to the present invention and a conventional electromagnetic clutch. Parts having similar functions are assigned similar notations.

### First Embodiment

FIG. 1 is a cross-sectional view of an electromagnetic clutch 10 according to a first aspect of the present invention. It has a structure similar to that of a known vehicular air-conditioner electromagnetic clutch, therefore that structure will be explained schematically.

A groove part 11a engaged with a V-belt transmitting the rotating force from the engine is formed on an external cylinder part 11. This external cylinder part 11 is formed on the outer circumference side of a driving side rotary body, that is, rotor 13, forming a magnetic path of the magnetic flux induced by an excitation coil 12. Note that, the rotor 13 is arranged rotationally at a front housing (not shown) of the compressor by a bearing 14, and an excitation coil 12 is fixed to the front housing by a roughly disc-shaped plate 15.

Note that, the excitation coil 12 and the plate 15 are at rest with respect to the compressor, therefore the coil 12 and plate 15 are normally called a stator 16.

Further, a hub 17 is a rotary body on the driven side coupled through a spline or other coupling mechanism to a shaft of the compressor. This hub 17 is coupled through a rubber or other elastic member 19 to an armature 18 attached to the rotor 13 by an electromagnetic attraction force.

Further, the surface 18a of the rotor 13 side of the armature 18 is an armature friction surface contacting the rotor 13 and generating frictional force. The surface 13a of the armature 18 side of the rotor 13 is a rotor friction surface contacting the armature 18 and generating frictional force.

That is, in the present embodiment, the disc part 13b of the rotor 13 at which the friction surface 13a is formed corresponds to the driving side clutch plate set forth in the claims, the armature 18 corresponds to the driven side clutch plate set forth in the claims, and the armature friction surface 18a and rotor friction surface 13a correspond to the contact surfaces of the clutch plates set forth in the claims.

Further, the rotor 13 and armature 18 are both made of ferrous metals superior in magnetization properties and in wear resistance, the rotor 13 is integrally formed with the external cylinder part 11 by a metal corresponding to S10C, and the armature 18 is made from a rolled steel sheet. The disc part 13b of the rotor forms the magnetic path of the magnetic field induced by the excitation coil 12, and the armature 18 is attached to the disc part 13b of the rotor by an electromagnetic attraction force.

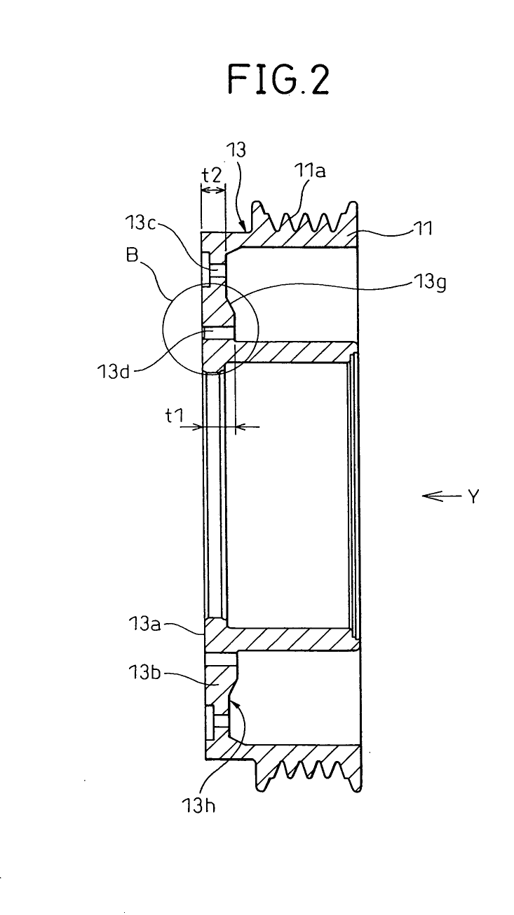

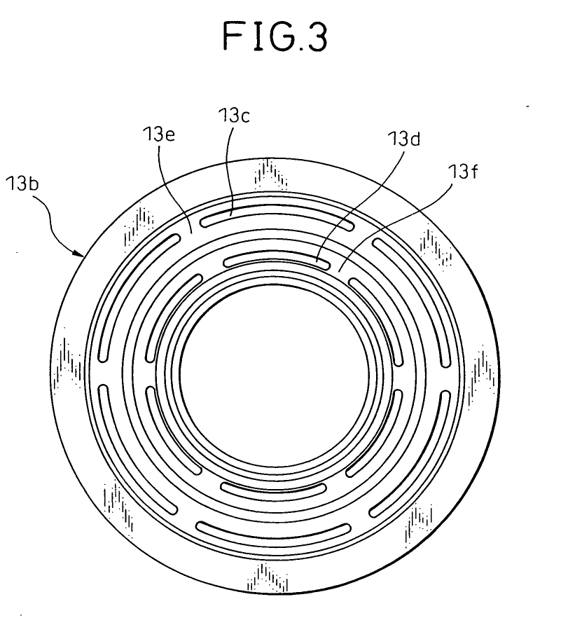

On the other hand, FIG. 2 is a cross-sectional view of the rotor 13, while FIG. 3 is a back view of the rotor 13 when the rotor 13 is seen from the opposite side 13h (from the Y-direction in FIG. 2) of the rotor friction surface 13a. The external cylinder part 11, as shown in FIG. 2, is integrally formed with the disc part 13b by spinning so that it is positioned on the opposite side of the rotor friction surface 13a from the disc part 13b of the rotor 13.

The disc part 13b of the rotor has a friction surface 13a to be pressed against the armature 18 and an opposite friction surface 13h on the opposite side of the friction surface 13a. The opposite friction surface 13h is provided with a slanted surface 13g from the inner circumference side to the outer circumference side. This slanted surface 13g may also be made a step shape. That is, it may be a slanted surface 13g having a 90° slope.

Further, regarding the thickness between the friction surface 13a and the opposite friction surface 13h, the thickness t1 of the inner circumference side is greater than the thickness t2 of the outer circumference side. Therefore, the thickness of the bridge parts 13f (explained later) of the inner circumference side may be made sufficiently greater than the thickness of the bridge parts 13e (explained later) of the outer circumference side. Therefore, stress is equally generated at the bridge parts of the inner circumference side and the outer circumference side, and fracture at the bridge parts of the inner circumference side and the outer circumference side may be prevented.

Further, the disc part 13b, as shown in FIG. 3, has pluralities of holes 13c and 13d arranged in a circumferential direction at the outer circumference side and the inner circumference side. The pluralities of holes 13c and 13d arranged in the circumferential direction are elongated holes long in the circumferential direction and short in the radial direction. Further, the bridge parts 13c and 13d are respectively formed adjacent in the circumferential direction between the hole parts 13c and 13d.

More specifically, the plurality of holes 13c arranged in the circumferential direction are formed at the outer circumference side of the disc part 13b, while bridge parts 13e are formed adjacent in the circumferential direction between the hole parts 13c. Further, the plurality of holes 13d arranged in the circumferential direction are formed at the inner circumference side of the disc part 13b, while bridge parts 13e are formed adjacent in the circumferential direction between the hole parts 13d.

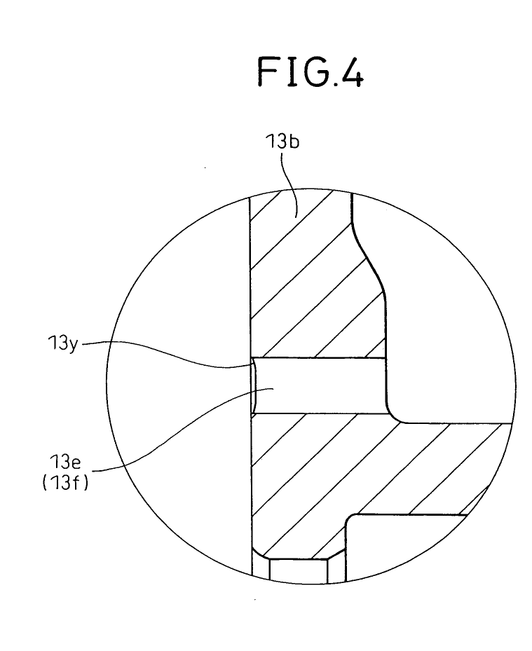

FIG. 4 is an enlarged view of a B part in FIG. 2. As shown in FIG. 4, coining (refer to JIS B 0122), a type of press forming, is applied to the bridge parts 13e (13f). Therefore, press formed parts 13y with rounded edges are formed by press forming using coining at the outer edges of the bridge parts 13e (13f).

Note that, the elongated holes 13c form a magnetic shield part designed so that the magnetic flux snakes between the disc part 13b and the armature 18 to thereby increase the electromagnetic attraction force between the two friction surfaces 18a and 13b. The armature 18 is similarly provided with hole parts forming a magnetic shield part.

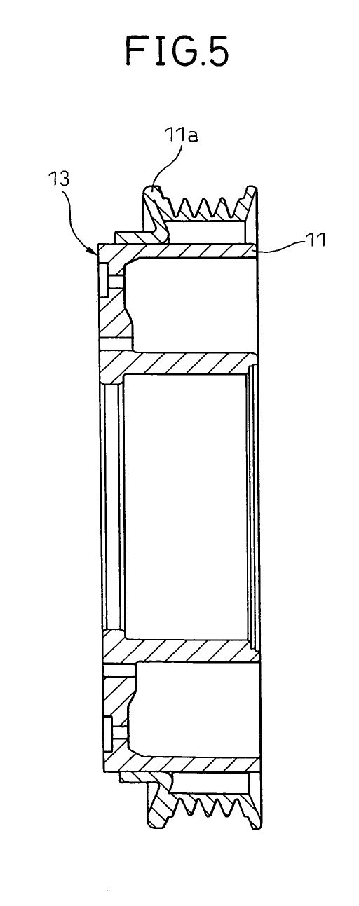

FIG. 5 is a cross-sectional view of a rotor of a second embodiment of the present invention. The only difference between the rotors 13 of the second embodiment and the first embodiment is that the groove part 11a engaged with the V-belt is separate from the rotor 13. As shown in FIG. 5, the separate groove part 11a is formed from a bent thin iron sheet which is press fit to the external cylinder part 11 and welded at six locations on its outer circumference by a laser beam. Compared to the first embodiment in which the groove part 11a is integrally formed with the rotor 13, the groove part 11a has the merit of being capable of reducing production costs. The rest of the structure of the rotor 13 of the second embodiment is exactly the same as the first embodiment, so its explanation is omitted.

### Other Embodiments

The clutch of the present invention was explained using as an example an electromagnetic clutch. Needless to say, however, the clutch of the present invention may also be applied to a hydraulic clutch or other clutch.

As explained above, it is possible to provide a clutch generating stress equally at the plurality of bridge parts of the driving side clutch plate and thereby preventing bridge parts from breaking easily when transmitting drive power.

While the invention has been described with reference to specific embodiments chosen for purpose of illustration, it should be apparent that numerous modifications could be made thereto by those skilled in the art without departing from the basic concept and scope of the invention.

1. A clutch provided with a rotor having an external cylinder part around which is wrapped a belt transmitting drive power of a drive source and a driving side clutch plate formed integrally with the external cylinder part, wherein
a driven side clutch plate is pressed against the driving side clutch plate so that frictional force is generated at contacting surfaces of the clutch plates and drive power is transmitted by the frictional force,
the driving side clutch plate has pluralities of holes arranged in a circumferential direction formed respectively at an outer circumference side and an inner circumference side and, further, has bridge parts formed respectively adjacent in a circumferential direction between the hole parts,
the driving side clutch plate has a friction surface to be pressed to the driven side clutch plate and an opposite friction surface on the opposite side of the friction surface, and
with respect to the thickness between the friction surface and the opposite friction surface, a thickness of the inner circumference side is greater than a thickness of the outer circumference side.

2. A clutch as set forth in claim 1, wherein the opposite friction surface is provided with a step or a slanted surface from the inner circumference side to the outer circumference side.

3. A clutch as set forth in claim 1, wherein the holes arranged in the circumferential direction are elongated holes long in the circumferential direction and short in the radial direction.

4. A clutch as set forth in claim 1, wherein the driving side clutch plate forms a magnetic path of a magnetic field induced by an excitation coil, and the driven side clutch plate is an armature attached to the driving side clutch plate by an electromagnetic attraction force.
